(19) United States
(12) Patent Application Publication
(10) Pub. No.: US 2002/0023355 A1
(43) Pub. Date: Feb. 28, 2002

(54) Hairdressing scissors

(76) Inventor: Shigeru Fujita, Tsubame-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/840,974

(22) Filed: Apr. 25, 2001

(30) Foreign Application Priority Data
Aug. 23, 2000 (JP) 2000-252131

(51) Int. Cl. B26B 13/28

(52) U.S. Cl. 30/254; 30/341

(57) ABSTRACT

Hairdressing scissors includes a pair of blades intersected in the shape of the letter X and each having an pivot hole in a midway part and a finger hole in a proximal part, a clamping blind nut, and a pivoting bolt penetrating the blades at the pivot holes for pivotally joining the blades in conjunction with the clamping blind nut. The pivoting bolt has a head part formed in the shape of a flat disc. One of the blades has a shallow depression formed around the pivot hole for embedding and fitting the head part of the bolt therein. The other of the blades has a nut depression formed around the pivot hole for inserting home the blind nut therein.

### BACKGROUND OF THE INVENTION

1. Field of the Invention

This invention relates to hairdressing scissors with an improved pivotal shaft.

2. Description of the Prior Art

The scissors, as universally known, are basically composed of a pair of blades adapted to intersect each other in the shape of the letter X, an axial hole penetrating both the blades, and a pivotal shaft inserted through the axial hole and enabled to join the intersecting parts pivotally. The pivotal shaft is formed by helically joining a clamping nut to a pivoting bolt. This pivoting bolt is provided with a dished head and has this dished head partly buried in one of the blades (the blade that is not jointly rotated with the pivot). The clamping nut is helically joined via a facing ring disposed on the surface of the blade to a bolt shank projected from the blade. Specifically, the clamping nut is wholly exposed from the blade, though the projection of the head part of the pivoting bolt from the surface of the blade is small.

When the clamping nut exists as projected outward from the blade, the projecting part has high possibility of contacting the hair under treatment and suffers the hair to slip in under the nut, with the result that the clamping nut will require a complicated cleaning after use. Further, in terms of appearance, the clamping nut in this construction cannot be rated as assuming a well-balanced shape.

The pivotal shaft mentioned above must be fastened with a certain degree of strength because it does not allow the scissors to manifest a smooth cutting action when it is loose in the axial direction. If it is fastened strongly, the friction between the blades and the friction between the pivotal shaft and the blades will possibly prevent the blades from being smoothly rotated relative to each other. For the purpose of enabling even the blades in a strongly fastened state to work smoothly against each other, it has been adopted means of interposing a resinous washer between the blades or disposing a washer facing ring in the head part of a pivoting bolt (JP-B-57-50517). Further, there have been known hairdressing scissors having internally incorporated therein in the place of a resinous washer a planar bearing formed by mounting bearing balls on a disc (JPA-08-846) and hairdressing scissors using a double-wall cylindrical bearing in the place of the planar bearing (JP-A-08-141225).

Particularly when the bearing is disposed on the head part of the pivoting bolt, the head part of the pivoting bolt is fated to project largely to the outside of the blade similarly to the clamping nut (JP-A-11-156067). Therefore, the boundary of motion between the head part of this bolt and the surface of the blade moving relative to the bolt coincides with the surface of the blade. As a result, the threads of hair adhering to the surface of the blade will possibly tend to enter the gap in the boundary of motion and hinder the operation of the scissors.

An object of this invention is to provide hairdressing scissors with an improved pivotal shaft, that lessens parts of a bolt and a nut projecting from the pivotal shaft and particularly prevents the hair from intruding into the gap between the head part of the bolt and the blade of the scissors.

### SUMMARY OF THE INVENTION

To attain the above object the invention provides hairdressing scissors which comprises a pair of blades intersected in the shape of the letter X and each having an pivot hole in a midway part and a finger hole in a proximal part, a clamping blind nut, and a pivoting bolt penetrating the blades at the pivot holes for pivotally joining the blades in conjunction with the clamping blind nut, the pivoting bolt having a head part formed in the shape of a flat disc, one of the blades having a shallow depression formed around the pivot hole for embedding and fitting the head part of the bolt therein, and the other of the blades having a nut depression formed around the pivot hole for inserting home the blind nut therein.

The head part of the pivoting bolt and the clamping nut are both buried in the blades and suffered to project only slightly and are allowed to assume a well-balanced appearance. At the same time, the boundaries of motion of the head part of the pivoting bolt and the surface of the relevant blade intersect rectangularly relative to the surface of the blade and allow no easy intrusion therein of the threads of hair adhering to the surfaces of the blades.

### BRIEF DESCRIPTION OF THE DRAWINGS

FIG. 1 is an overall perspective view illustrating an embodiment of hairdressing scissors according to this invention.

FIG. 2 is an exploded perspective view thereof.

FIG. 3 is a magnified cross-sectional view of the pivot portions of the blades of the scissors.

FIG. 4 is a magnified cross-sectional view of the state of pivotal union.

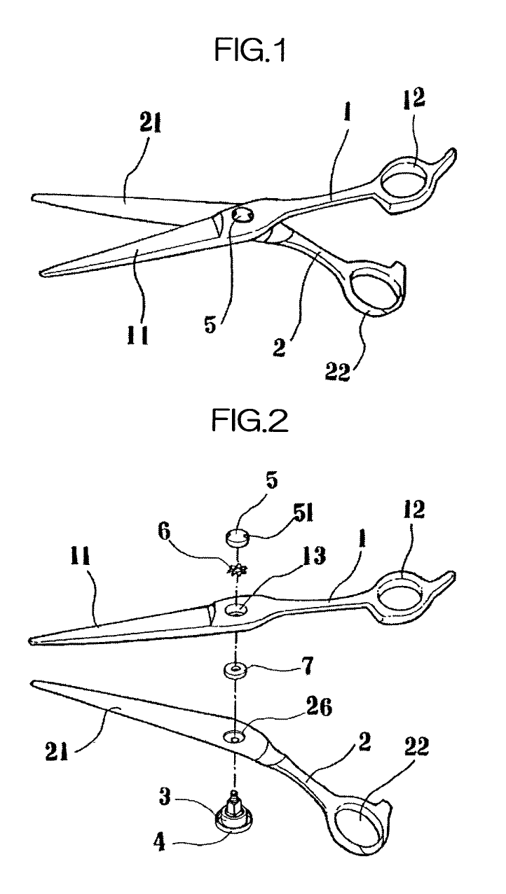

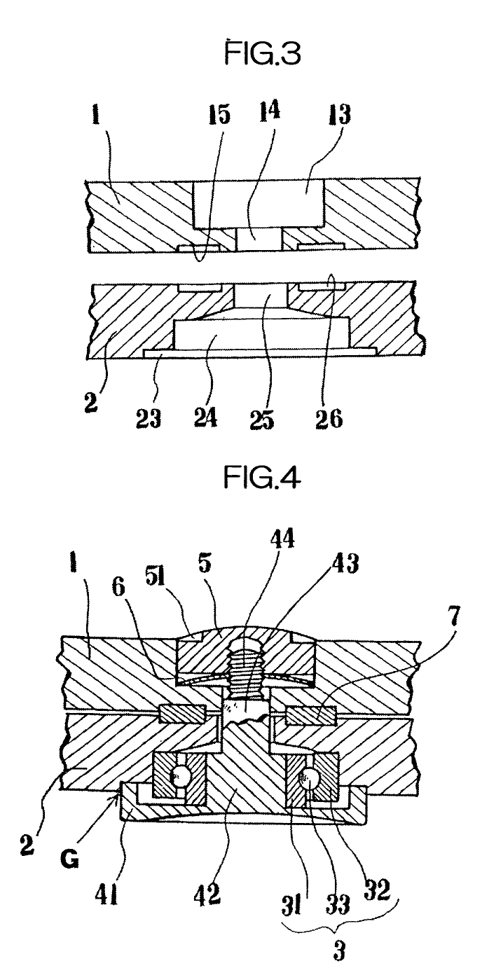

### DETAILED DESCRIPTION OF THE PREFERRED EMBODIMENT

Now, an embodiment of this invention will be described below. The hairdressing scissors contemplated by this invention are basically composed of a pair of blades 1, 2, a pivoting bolt 4 having a bearing 3 attached thereto, a clamping nut 5, a facing ring 6 safe from loosening, and a resinous washer 7.

The blades 1, 2, similarly in the conventional hairdressing scissors, are provided with blade parts 11, 21 and finger holes 12, 22 and are adapted to intersect each other in the shape of the latter X and join the intersecting parts pivotally. Prescribed an angular pivot hole 14 and a circular pivot hole 25 are formed in the intersecting portions. One of the blades (the blade moving jointly with the pivotal shaft) 1 is formed on one surface thereof around the pivot hole 14 with a nut depression 13 deep enough to embed the clamping nut 5 on the bottom surface of the nut depression 13. The blade 1 is further formed on the opposite surface thereof with a ring depression 15 for the washer 7.

The other blade (the blade moving relative to the pivotal shaft) 2 is formed on one surface thereof around the pivot hole 25 with a shallow depression 23 for embedding a head part 41 of the pivoting bolt 4 and a depression 24 for accommodating therein the bearing 3. The blade 2 is further formed on the opposite surface thereof with an annular depression 26 for the washer 7. The bottom surface of the accommodating depression 24 assumes a sloped face shallow on the periphery and deep at the center.

The pivoting bolt 4 is formed in the shape of a flat disc. The head part 41 thereof has an arcuately depressed upper surface. The shank part of this bolt forms a circular shank part 42, an angular shank part 43, and a screwed shank part 44 successively in the order mentioned from the head part 41. The circular shank part (bolt shank) 42 has the bearing 3 attached thereto. The bearing 3 is a double-wall cylinder and has bearing balls interposed between an outer cylindrical part 32 and an inner cylindrical part 31.

The clamping nut 5 is a blind nut containing no through axial hole therein and is provided on the upper surface thereof with a clamping depressing 51. The facing ring 6 is provided with a multiplicity of toes projected radially from the annular center to the periphery and consequently endowed with a function to prevent the nut from loosening.

The pivotal shaft, therefore, is formed so as to render the scissors ready for use by superposing the intersecting parts via the washer 7, inserting the pivoting bolt 3 into the superposed intersecting parts from the other blade 2 side inward, disposing the facing ring 6 on the bottom of the nut depression 13, and helically joining the clamping nut 5 with the screwed shank part 44 projecting inside the nut depression 13.

Owing to the construction described above, particularly the head part 41 of the pivoting bolt 4 has the outer peripheral surface thereof inserted as closely approximating to the inner peripheral surface of the shallow depression 23 and enabled to lessen the outward projection thereof from the blades. At the same time, the clamping nut 5 as a blind nut is nearly wholly accommodated in the nut depression 13 and enabled to lessen the projection of the pivotal shaft and exalt the front-rear balance of the blades. Moreover, the gap (enclosed with the boundaries of motion) G between the blade 2 and the pivoting bolt 4 that tends to entrain the hair in consequence of its own motion is fated to form perpendicularly to the surface of the blade 2 during the operation thereof. Therefore, the possibility that the gap will engulf the threads of hair adhering to the surfaces of the blades is greatly diminished. Even when the threads of hair happen to adhere to the head part of the pivoting bolt 4, the possibility that the adhering threads of hair will move and enter the gap G is nil because the head part of the pivoting bolt 4 forms an arcuately depressed upper surface.

As described in the foregoing, in the pivotal shaft of hairdressing scissors, the present invention adopts the construction that comprises the head part of the pivoting bolt formed in the shape of a flat disc, the pivot hole of one of the blades formed with a shallow depression for embedding and fitting the head part of the bolt therein, and the pivot hole of the other blade formed with a nut depression for burying the blind nut therein. Therefore, the invention represses the outward projection of the pivoting portion, enhances the balance of the scissors, and lessens the intrusion of hair into the pivoting portion.

What is claimed is:

1. Hairdressing scissors comprising:
a pair of blades intersected in the shape of the letter X and each having an pivot hole in a midway part and a finger hole in a proximal part;
a clamping blind nut, and
a pivoting bolt penetrating the blades at the pivot holes for pivotally joining the blades in conjunction with the clamping blind nut,
the pivoting bolt having a head part formed in the shape of a flat disc,
one of the blades having a shallow depression formed around the pivot hole for embedding and fitting the head part of the bolt therein,
the other of the blades having a nut depression formed around the pivot hole for inserting home the blind nut therein.

2. Hairdressing scissors according to claim 1, wherein the head part of bolt has an arcuately depressed upper surface.

3. Hairdressing scissors according to claim 1, further comprising a depression for a bearing formed inward of the shallow depression for the head part of the pivoting bolt and a bearing interposed between the bolt and the one blade and mounted on a shank of the bolt.
